(19) United States
(12) Patent Application Publication
(10) Pub. No.: US 2019/0372214 A1
(43) Pub. Date: Dec. 5, 2019

(54) Antenna Structure Having Dual Feeds and Improved Isolation

(71) Applicant: Senao Networks, Inc., Taoyuan City (TW)

(72) Inventors: Chih Jen Hsiao, Taoyuan (TW); Chi Yang Chiu, Taoyuan (TW); Kuo Lun Hung, Taoyuan (TW); Wen Tang Lee, Taoyuan (TW); Kuan Hsien Chang, Taoyuan (TW)

(21) Appl. No.: 15/992,175

(22) Filed: May 30, 2018

(51) Int. Cl. H01Q 1/52; H01Q 9/04; H01Q 21/00; H01Q 21/06

(52) U.S. Cl. CPC H01Q 1/523; H01Q 21/065; H01Q 21/0025; H01Q 9/045

(57) ABSTRACT

Disclosed is a single physical antenna structure that has two ports and two ground points and functions as two separate and independent subantennas. Although the two subantennas are in close physical proximity and are physically connected, the antenna structure provides strong isolation to allow the subantennas to function independently of one another, particularly useful in MU-MIMO applications.

### BACKGROUND

The present invention relates to a single antenna structure that functions as two separate antennas, which may be referred to as subantennas, and wireless communication devices making use of such antenna structures. Despite being in close proximity and physically connected, the antenna structure provides strong isolation between the subantennas. The use of the antenna structures of the present disclosure allows for the reduction of size and cost of wireless communication devices as well as simplifying the process for designing such wireless communication devices.

There is a need for wireless communication devices to be equipped with an ever-increasing number of functional antennas, particularly those devices that provide network services to other devices, such as wireless routers and access points. Today, even an ordinary consumer household may have numerous devices in need of access to the Internet, including personal computers, smartphones, tablets, smart TVs, and video game consoles, not to mention smart home devices such as connected home automation hubs, smart doorbells, and security cameras. A typical office may have hundreds, thousands, or even more wireless devices to support. The explosion of the Internet of things is placing further burdens on network infrastructure everywhere.

A conventional approach for supporting more wireless devices is to simply add more access points to a network. However, this can be costly and may not be feasible in all environments. Many homes, for instance, do not have the infrastructure to support multiple network access points. In part to address this problem, devices with multiple-input-multiple-output (MIMO) capabilities were introduced. Routers and access points with MIMO capabilities can use multiple antennas to transmit to and/or receive signals from another device, which causes signal transmissions to be completed more quickly and allows a router or access point to move on more quickly to serving another device, and thereby improving overall network performance. More recently, devices with multiple-user-multiple-input-multiple-output (MU-MIMO) have started coming on the market. Routers and access points with MU-MIMO capabilities can use multiple antennas to transmit to and/or receive signals from multiple other devices simultaneously.

The introduction of MIMO and MU-MIMO capabilities brings challenges to the design of wireless communication devices. It may be desirable, for instance, to equip a device with up to twelve or even more antennas. However, having so many antennas in a single device may cause them to interfere with each other. One conventional approach to improve the signal isolation between antennas is simply to place them at a physical remove from each other. However, this becomes more difficult to do as more antennas are added and may require devices to be made physically larger in order to fit more antennas. This increases material and manufacturing costs and also may be disfavored by consumers.

Accordingly, there is a need for an antenna design that allows for more compact product designs when multiple antennas need to be included.

### BRIEF DESCRIPTION OF THE DRAWINGS

Various embodiments in accordance with the present disclosure will be described with reference to the drawings, in which:

FIG. 1 shows an example of a wireless communication system that may make use of antenna structures that are embodiments of the present disclosure.

FIG. 2A shows a 2D view of a flat antenna pattern according to an embodiment of the present disclosure.

FIG. 2B shows the same antenna pattern of FIG. 2A with indications of the center line along which the pattern is symmetrical and edges along which the pattern can be folded.

FIG. 2C shows the same antenna pattern of FIG. 2A with indications of edges of the pattern for which dimensions can be adjusted.

FIG. 2D shows a 3D angled view of the front and top of an antenna structure fashioned from the antenna pattern of FIG. 2A.

FIG. 2E shows a 3D angled view of the back and top of an antenna structure fashioned from the antenna pattern of FIG. 2A.

FIG. 3 shows a circuit diagram representing the antenna structure shown in FIG. 2D and FIG. 2E.

FIG. 4 shows the isolation characteristics of an embodiment of the antenna structure operating at a center frequency of approximately 5.50 GHz.

FIG. 5 shows the return loss of one of the subantennas of an antenna structure according to one embodiment.

FIG. 6 shows the 2D radiation patterns of the antenna structure shown in FIG. 2D and FIG. 2E according to one embodiment.

FIG. 7A shows a 2D view of a flat antenna pattern according to an embodiment of the present disclosure.

FIG. 7B shows the same antenna pattern of FIG. 7A with indications of the center line along which the pattern is symmetrical and edges along which the pattern can be folded.

FIG. 7C shows a 3D angled view of the front and top of an antenna structure fashioned from the antenna pattern of FIG. 7A.

FIG. 7D shows a 3D angled view of the back and top of an antenna structure fashioned from the antenna pattern of FIG. 7A.

FIG. 8 shows a mounting plate of a wireless communication device on which have been affixed antenna structures according to an embodiment of the present disclosure.

### DETAILED DESCRIPTION

Systems and methods in accordance with various embodiments of the present disclosure may overcome one or more of the aforementioned and other deficiencies experienced in conventional approaches to antenna design, particularly antenna design for wireless communication devices having the need to include multiple antennas, such as for MU-MIMO applications. In particular, various approaches provide for a single physical antenna structure comprising two subantennas that each functions as a separate and independent antenna.

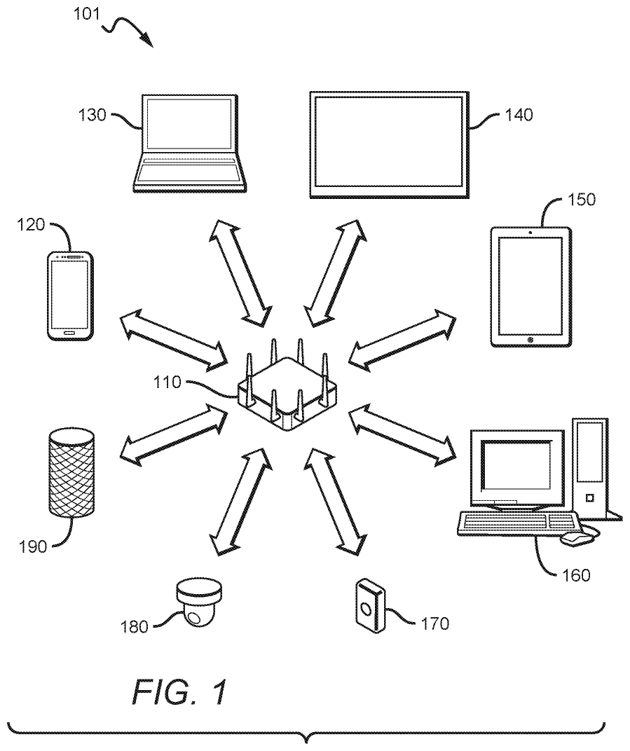

FIG. 1 shows an example of a wireless communication system 101 that may make use of antenna structures that are embodiments of the present disclosure.

Wireless access point 110 is communicatively coupled to various devices, including, as shown for example, smartphone 120, notebook computer 130, smart TV 140, tablet computer 150, desktop computer 160, smart doorbell 170, security camera 180, and smart speakers 190. Of course, any number of other devices may be connected to wireless access point 110. Wireless access point 110 may provide access to a network, such as the Internet, to each of the other devices. Wireless access point 110 has MU-MIMO capabilities and may simultaneously transmit to and/or receive signals from more than one device. Instead of a wireless access point, the system 101 may make use of a one or more wireless routers, including mesh router systems, and/or other devices that can wirelessly communicate with client devices and provide access to the Internet or another network.

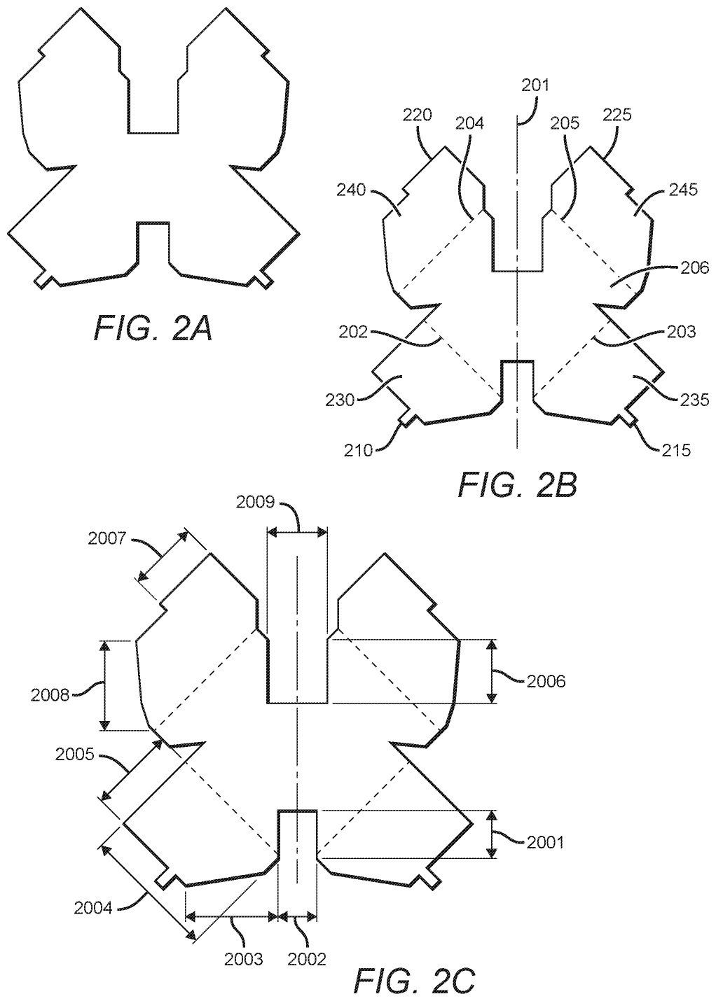

FIG. 2A is a 2D view of a flat dual-feed antenna pattern according to an embodiment of the present invention. This pattern may be particularly suitable for operation on and around the 5 GHz frequency band. The antenna pattern is fashioned from a single piece of material suitable for transmitting and receiving electromagnetic radiation as well as conducting electric currents, such as tinplate, copper, aluminum, or stainless steel. As the antenna pattern is flat, it can be made by a stamping process.

Referring to FIG. 2B, it is seen that the pattern is symmetrical along a center line 201, which is shown here for illustrative purposes and does not form part of the structure. As explained in more detail below, each half of the antenna pattern as divided by the center line can operate as an independent antenna, referred to herein as a subantenna. The first subantenna includes first port 210 and first ground point 220. The second subantenna includes second port 215 and second ground point 225.

It may be appreciated that each half of the antenna pattern, or each subantenna, may be viewed as a planar antenna. Although the two subantennas are physically joined, there is high isolation between them because the structure between them acts as a filter. In particular, the antenna bridge 209 imposes a substantial capacitance between the two subantennas.

After the flat antenna pattern is fabricated, it can be folded down approximately 90 degrees along edges 202, 203, 204, and 205 so that each of sides 230, 235, 240, and 245 is perpendicular to the top surface 206, creating a box-like shape.

FIG. 2C illustrates edges of the antenna pattern that may be tuned to adjust its operational characteristics. According to one embodiment, edge 2001 may be approximately 5.05 mm, edge 2002 may be approximately 4 mm, edge 2003 may be approximately 8 mm, edge 2004 may be approximately 13.5 mm, edge 2005 may be approximately 7.6 mm, edge 2006 may be approximately 8.75 mm, edge 2007 may be approximately 10 mm, edge 2008 may be approximately 9.4 mm, and edge 2009 may be approximately 5.05 mm. Alternatively, different dimensions may be used.

FIGS. 2D and 2E are 3D views of the dual-feed antenna structure from different vantage points after the edges 202, 203, 204, and 205 shown in FIG. 2B have been folded. In this configuration, the antenna structure is suitable for placement into an electronic device.

The top surface 206 of the antenna 200 has a substantially square or rhombus shape with a front notch 207 and back notch 208 cut out from it. The antenna bridge 209 imposes a capacitance between the two subantennas.

For ease of discussion, reference is made to first subantenna 250 and second subantenna 255. First subantenna 250 and second subantenna 255 are mirror images of each other along center line 201. First subantenna 250 and second subantenna 255 are connected by antenna bridge 209, which acts as a capacitance structure.

First subantenna 250 includes a first front vertical plane 230 and a first back vertical plane 240. First front vertical plane 230 and a first back vertical plane 240 are arranged in a substantially perpendicular fashion to each other and to top surface 206. First front vertical plane 230 includes a first port 210, which may be connected to circuitry in an electronic device such as access point 110. First front vertical plane 230 is depicted here as having substantially a parallelogram shape, but different shapes may be used. First back vertical plane 240 includes a first ground point 220, which may be connected to ground in an electronic device such as access point 110. First back vertical plane 240 is depicted here as having an irregular shape, but different shapes may be used.

Second subantenna 255 includes a second front vertical plane 235 and a second back vertical plane 245. Second front vertical plane 235 and a second back vertical plane 245 are arranged in a substantially perpendicular fashion to each other and to top surface 206. Second front vertical plane 235 includes a second port 215, which may be connected to circuitry in an electronic device such as access point 110. Second front vertical plane 235 is depicted here as having substantially a parallelogram shape, but different shapes may be used. Second back vertical plane 245 includes a second ground point 225, which may be connected to ground in an electronic device such as access point 110. Second back vertical plane 245 is depicted here as having an irregular shape, but different shapes may be used.

Each of first subantenna 250 and second subantenna 255 operates as an independent and separate antenna. This is the case even though first subantenna 250 and second subantenna 255 are in close proximity and even physically joined to each other. The structure of the antenna acts as a filter between first subantenna 250 and second subantenna 255, which results in high isolation between them.

The use of terms such as “top,” “front,” and “back” in reference to the embodiments is simply to provide for ease of discussion and understanding and should not be taken to mean that the antenna structures described herein are intended to operate only in certain physical orientations. The antenna structures are operative and effective when used in any physical orientation.

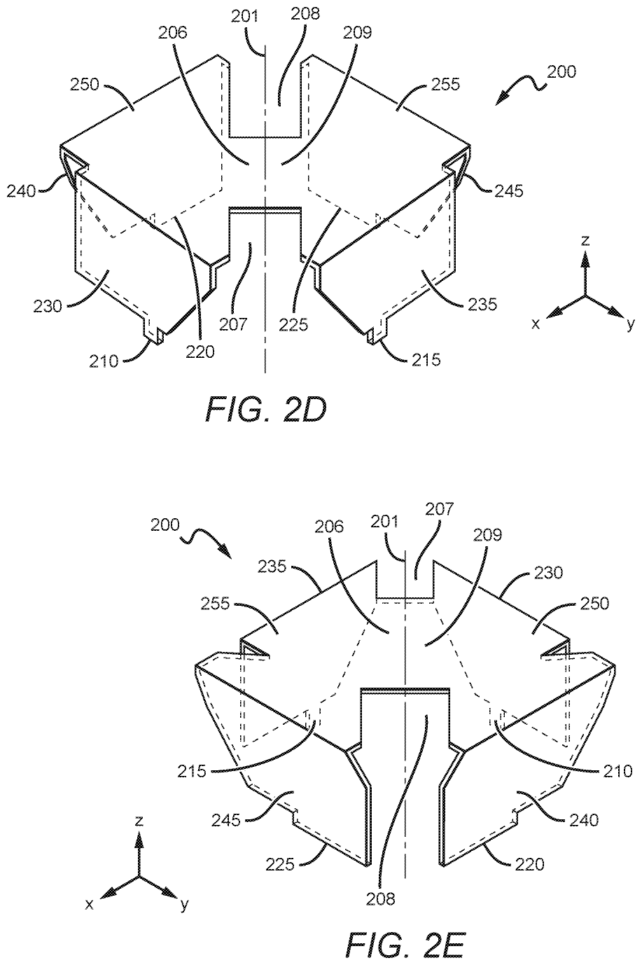

FIG. 3 depicts a circuit diagram of the antenna structure. L₁ and C₁ determine the operating frequency of the first subantenna according to the following equation:

$${f}_{1} = \frac{1}{2 π \sqrt{{L}_{1} {C}_{1}}}$$

The values of L₁ and C₁ are largely determined by the dimensions of edges 2003, 2004, 2005, 2007, and 2008 shown in FIG. 2C. Similarly, L₂ and C₂ determine the operating frequency of the second subantenna according to the following equation:

$${f}_{2} = \frac{1}{2 π \sqrt{{L}_{2} {C}_{2}}}$$

As the antenna is symmetrical along the center line, the operating frequency of the second antenna is the same as the first subantenna. It can be appreciated that the two subantennas can be made to operate at different frequencies if they were made asymmetrical to each other.

L₁, L₂, and C₀ determine the operating frequency of the filter between the feed ports of the two subantennas according to the following equation:

$${f}_{f} = \frac{1}{2 π \sqrt{( {L}_{1} \vert \vert {L}_{2} ) {C}_{0}}}$$

The values of L₁, L₂, and C₀ are largely determined by the dimensions of edges 2001, 2002, 2006, and 2009 shown in FIG. 2C. The operating frequency of the filter can be tuned by adjusting the dimensions of edges 2001, 2002, 2006, and 2009.

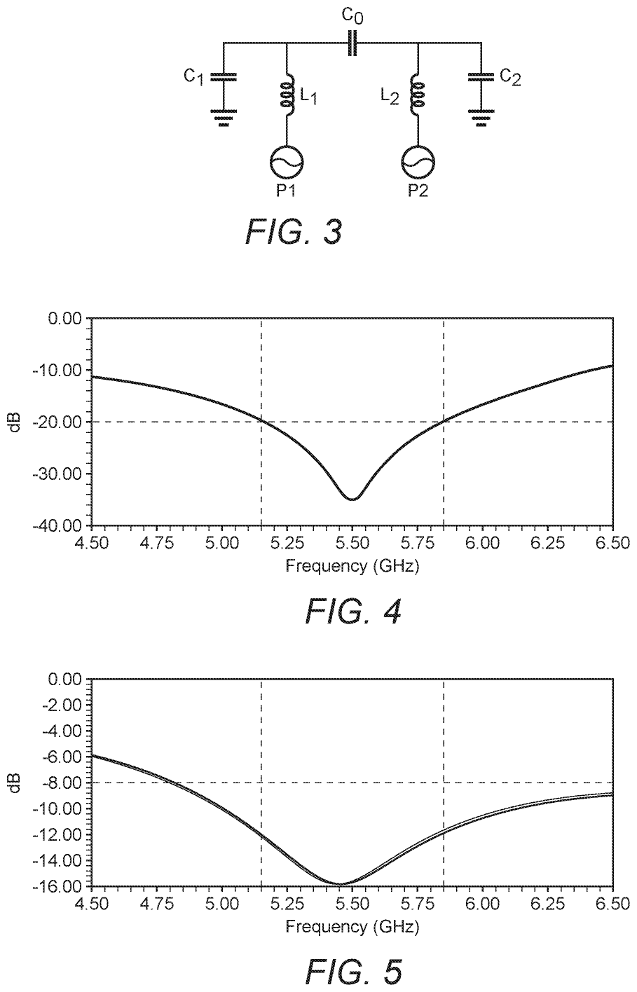

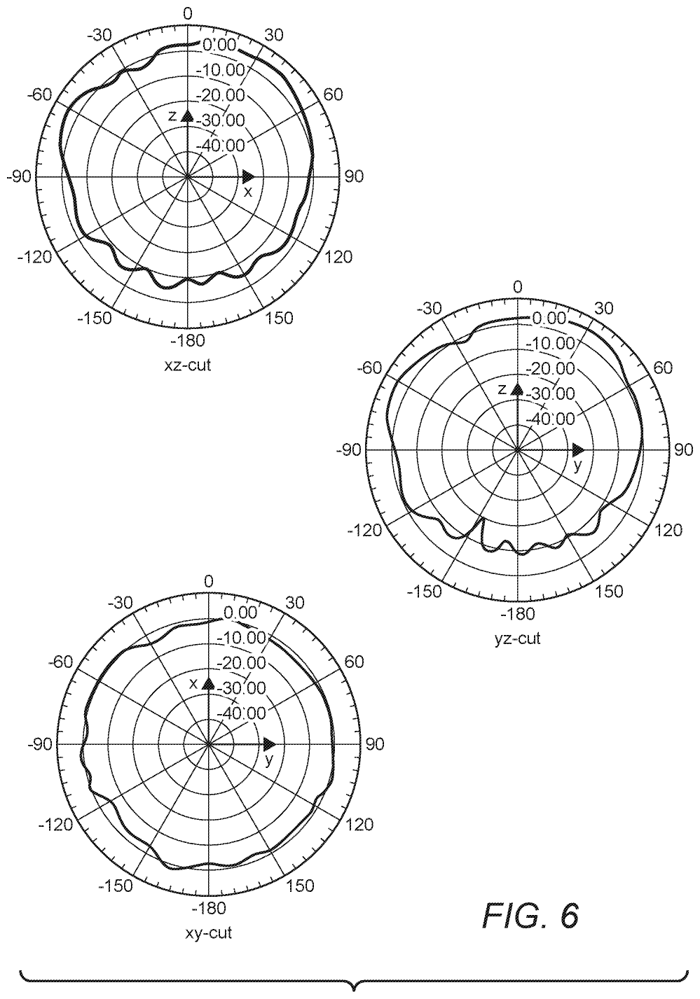

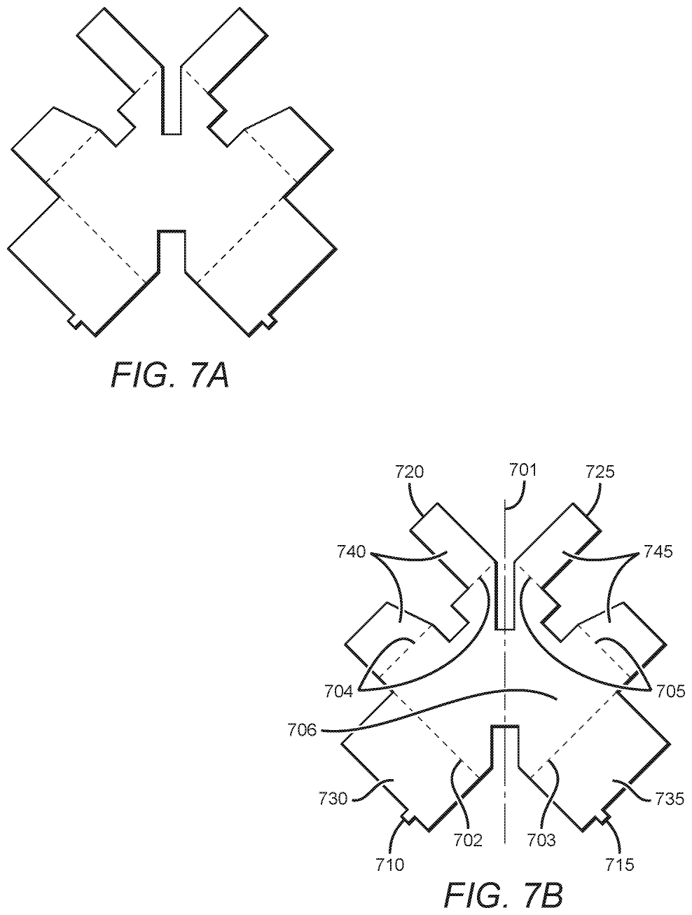

The operating frequency of the filter is understood to be a frequency at which the filter exhibits good isolation. FIG. 4 depicts the frequency response of a good filter centered around 5.50 GHz. For instance, the isolation between the two subantennas on the same physical structure is approximately −35 dB at the center frequency and is approximately −20 dB at approximately 5.15 GHz and 5.85 GHz. FIG. 5 shows that the subantennas exhibit very low return loss across the entire 5.15 GHz to 5.85 GHz frequency band, and even beyond, due to the effectiveness of the filter. FIG. 6 depicts the 2D radiation pattern of each subantenna along the XZ, YZ, and XY dimensions, as referenced in FIGS. 2D and 2E, showing an efficiency of approximately 65% and antenna gain of 4.5 dBi.

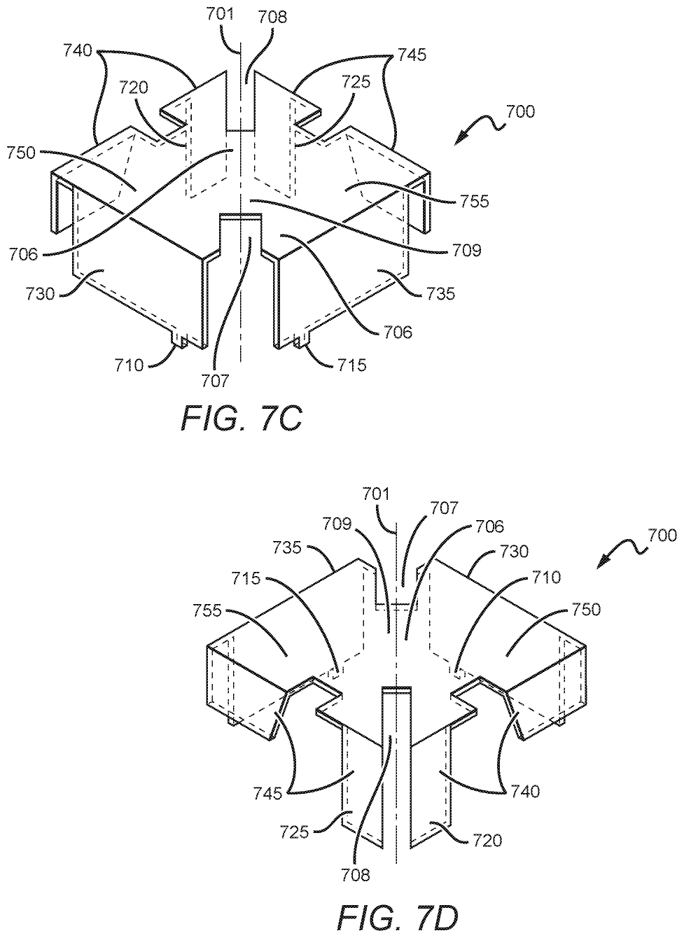

FIG. 7A shows a flat dual-feed antenna pattern according to an embodiment of the present invention. This pattern may be particularly suitable for operation on the 2.4 GHz frequency band. Referring to FIG. 7B, it is seen that the pattern is symmetrical along a center line 701. Each half of the antenna pattern as divided by the center line forms a subantenna that can operate as an independent antenna. The first subantenna includes first port 710 and first ground point 720. The second subantenna includes second port 715 and second ground point 725.

After the flat antenna pattern is fabricated, it can be folded down approximately 90 degrees along edges 702, 703, 704, and 705 so that each side 730, 735, 740, and 745 is perpendicular to the top surface 706, creating a box-like shape.

FIGS. 7C and 7D are 3D views of the dual-feed antenna structure from different vantage points after the edges 702, 703, 704, and 705 of the antenna pattern shown in FIGS. 7A and 7B have been folded. In this configuration, the antenna structure is suitable for placement into an electronic device.

The top surface 706 of the antenna structure 700 has a substantially square or rhombus shape with a front notch 707 and back notch 708 cut out from it. Antenna 700 structure is symmetrical along center line 701.

For ease of discussion, reference is made to first subantenna 750 and second subantenna 755. First subantenna 750 and second subantenna 755 are mirror images of each other along center line 701. First subantenna 705 and second subantenna 755 are connected by antenna bridge 709.

First subantenna 750 includes a first front vertical plane 730 and a first back vertical plane 740. First front vertical plane 730 and a first back vertical plane 740 are arranged in a substantially perpendicular fashion to each other and to top surface 706. First front vertical plane 730 includes a first port 710, which may be connected to circuitry in an electronic device such as access point 110. First front vertical plane 730 is depicted here as having substantially a rectangular shape, but different shapes may be used. Along the same plane as the first back vertical plane 740 is a first ground point 720, which may be connected to ground in an electronic device such as access point 110. First back vertical plane 740 is depicted here as comprising a parallelogram shape, but different shapes may be used. First ground point 720 is depicted here as having a rectangular shape, but different shapes may be used. First ground point 720 is perpendicular to the top surface 706.

Second subantenna 755 includes a second front vertical plane 735 and a second back vertical plane 745. Second front vertical plane 735 and a second back vertical plane 745 are arranged in a substantially perpendicular fashion to each other and to top surface 706. Second front vertical plane 735 includes a second port 715, which may be connected to circuitry in an electronic device such as access point 110. Second front vertical plane 735 is depicted here as having substantially a rectangular shape, but different shapes may be used. Along the same plane as the first back vertical plane 745 is a first ground point 725, which may be connected to ground in an electronic device such as access point 110. Second back vertical plane 745 is depicted here as comprising a parallelogram shape, but different shapes may be used. Second ground point 725 is depicted here as having a rectangular shape, but different shapes may be used. Second ground point 725 is perpendicular to the top surface 706.

Each of first subantenna 750 and second subantenna 755 operates as an independent and separate antenna. This is the case even though first subantenna 750 and second subantenna 750 are in close proximity and physically joined to each other. The structure of the antenna acts as a filter between first subantenna 750 and second subantenna 755, which results in high isolation between them. In particular, the antenna bridge 709 imposes a substantial capacitance between the two subantennas.

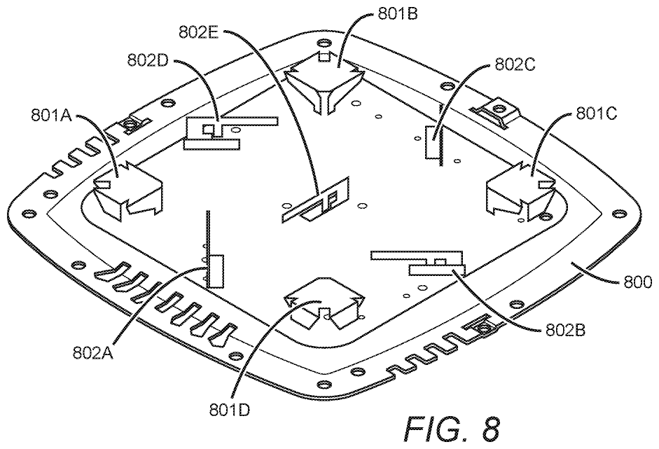

FIG. 8 illustrates an example usage of the antenna structures disclosed in this application. Mounting plate 800 may be part of the structure of an electronic device such as access point 101. For instance, mounting plate 800 may be part of or affixed to the bottom outer cover of an electronic device.

Affixed to the corners of the mounting plate are dual-feed antenna structures 801A, 801B, 801C, and 801D. The antennas structures 801A, 801B, 801C, and 801D provide the electronic device with eight functional antennas. The antennas structures 801A, 801B, 801C, and 801D may all operate at the same center frequency or may operate at different center frequencies, depending on the desired features for the device. The placement of the antennas structures 801A, 801B, 801C, and 801D may be determined by known methods to obtain desired results such as a minimum isolation between the structures; however, the present disclosure greatly simplifies the design of electronic devices because the isolation between pairs of subantennas on a single antenna structure is already guaranteed. The use of the dual feed antenna structures of the present disclosure also allows electronic devices to be made smaller due to having fewer antenna structures that need to be physically separated by some distance to provide for adequate isolation.

It would be understood, of course, that more or fewer antenna structures 801 may be used in an electronic device depending on the number of antennas desired. Optionally, conventional single feed antenna structures 802A, 802B, 802C, 802D, and 802E can also be affixed to the mounting device to provide for additional functional antennas, such as antennas operating at a different frequency band.

As used in the above description and in the claims that follow, words such as “a,” “an,” and “the” include plural references unless the context clearly indicates otherwise. Also, as used in the description herein and throughout the claims that follow, the meaning of “in” includes “in” and “on” unless the context clearly indicates otherwise.

The above description illustrations various embodiments along with examples of how aspects of some embodiments may be implemented. These illustrations are not necessarily intended to limit the scope of the inventions described herein and as defined by the following claims. Based on the above disclosure and the following claims, other arrangements, embodiments, implementations and equivalents may be employed without departing from the scope hereof as defined by the claims.

What is claimed is:

1. A dual-feed antenna comprising:
an antenna structure fashioned from a single piece of electrically conductive material;
wherein the antenna structure comprises two symmetrical subantennas connected by an antenna bridge that imposes a capacitance between the two subantennas;
wherein each of the two subantennas comprises a feed point and a ground point;
wherein each of the two subantennas is operable to transmit and receive radio signals independently of the other subantenna.

2. The dual-feed antenna of claim 1, wherein each of the two subantennas is a planar antenna.

3. The dual-feed antenna of claim 1, wherein the antenna structure is fashioned from a flat piece of material that is folded along a plurality of edges to create a box-like shape.

4. The dual-feed antenna of claim 1, wherein the two subantennas operate on the same center frequency.

5. The dual-feed antenna of claim 4, wherein the center frequency is approximately 5.5 GHz.

6. The dual-feed antenna of claim 4, wherein the center frequency is approximately 2.4 GHz.

7. The dual-feed antenna of claim 1, wherein each of the two subantennas operates on a different center frequency.

8. A communication device comprising:
a plurality of dual-feed antennas, wherein each dual-feed antenna comprises an antenna structure fashioned from a single piece of electrically conductive material;
wherein the antenna structure comprises two symmetrical subantennas connected by an antenna bridge that imposes a capacitance between the two subantennas;
wherein each of the two subantennas comprises a feed point and a ground point;
wherein each of the two subantennas is operable to transmit and receive radio signals independently of the other subantenna;
a plurality of single-feed antennas;
wherein the plurality of dual-feed antennas operate on a first center frequency; and
the plurality of single-feed antennas operate on a second center frequency that differs from the first center frequency.

9. The communication device of claim 8, wherein the first center frequency is approximately 5.5 GHz and the second center frequency is approximately 2.4 GHz.

10. The communication device of claim 8, wherein the communication device further comprises:
four of said dual-feed antennas;
four of said single-feed antennas;
wherein the four dual-feed antennas and four single-feed antennas are operable as twelve antennas that may transmit and receive radio signals independently.

11. The communication device of claim 8, wherein each subantenna of each of the plurality of dual-feed antennas is a planar antenna.

12. The communication device of claim 8, wherein the antenna structure of each of the plurality of dual-feed antennas is fashioned from a flat piece of material that is folded along a plurality of edges to create a box-like shape.

13. A communication device comprising:
a plurality of dual-feed antennas, wherein each of the dual-feed antenna comprises
an antenna structure fashioned from a single piece of electrically conductive material;
wherein the antenna structure comprises two symmetrical subantennas connected by an antenna bridge that imposes a capacitance between the two subantennas;
wherein each of the two subantennas comprises a feed point and a ground point;
wherein each of the two subantennas is operable to transmit and receive radio signals independently of the other subantenna;
wherein at least a first dual-feed antenna of the plurality of dual-feed antennas operates on a first center frequency;
at least a second dual-feed antenna of the plurality of dual-feed antennas operates on a second center frequency that differs from the first center frequency.

14. The communication device of claim 13, wherein the communication device further comprises:
at least four of a first type of dual-feed antennas that operate on the first center frequency; and
at least two of a second type of dual-feed antennas that operate on the second center frequency.

15. The communication device of claim 13, wherein the first center frequency is approximately 5.5 GHz and the second center frequency is approximately 2.4 GHz.

16. The communication device of claim 13, wherein each subantenna of each of the plurality of dual-feed antennas is a planar antenna.

17. The communication device of claim 13, wherein the antenna structure of each of the plurality of dual-feed antennas is fashioned from a flat piece of material that is folded along a plurality of edges to create a box-like shape.
